(19) United States
(12) Patent Application Publication
(10) Pub. No.: US 2010/0017318 A1
(43) Pub. Date: Jan. 21, 2010

(54) METHODS AND APPARATUS FOR A DOWNLOADABLE FINANCIAL TRANSACTION PRINTER

(75) Inventor: John Hilbert, Glendale, CA (US)

Correspondence Address: FITZPATRICK CELLA HARPER & SCINTO, 1290 Avenue of the Americas, NEW YORK, NY, 10104-3800, US

(73) Assignee: FUTURELOGIC, INC., Glendale, CA (US)

(21) Appl. No.: 12/374,028

(22) PCT Filed: Jul. 30, 2007
(86) PCT No.: PCT/US07/74776

§ 371 Date: Jun. 24, 2009

Related U.S. Application Data
(60) Provisional application No. 60/834,029, filed on Jul. 28, 2006.

(51) Int. Cl. G06Q 40/00

(52) U.S. Cl. 705/35

(57) ABSTRACT

Method and apparatus for a downloadable financial transaction printer supporting multiple interfaces and single encoding for worldwide languages configuration. The financial transaction printer interfaces with multiple host systems and multiple gaming machine protocols, downloads application code or code patches, receives printer maintenance instructions, arbitrates print jobs received from various communication interfaces, supports worldwide languages, and utilizes firmware version consolidation whereby fewer firmware versions are required to support worldwide requirements, such as regional and jurisdictional requirements. The financial transaction printer further includes security features for gaming regulatory requirements, memory protection, and preventing the execution of downloaded code on unauthorized hardware. The financial transaction printer further includes segmented memory for content related to each communication interface, gaming machine, or host system, among others. Additionally, the financial transaction printer supports Unicode, configuration to worldwide languages, configuration to multiple protocols, and configuration to prior firmware versions for backward compatibility, among others.

### CROSS REFERENCE TO RELATED APPLICATION

The present application claims the benefit us U.S. Provisional Application No. 60/834,029 filed Jul. 28, 2006 the contents of which are incorporated by reference as if stated in full herein.

### BACKGROUND OF THE INVENTION

This invention relates to printers that print financial transaction records, more specifically to printers used in Cashless Gaming Machines that produce cash-out paper vouchers that may be redeemed for cash or inserted into the bill acceptor in the same or another Cashless Gaming Machine at a participating casino, at which point the system will recognize the voucher, redeemed it and place the appropriate amount of playing credits on the game.

Over the last several years, cashless enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. Practical field experience with the application has illustrated that there are areas for improvement in current printer designs and implementation within the game.

One area for improvement relates to the financial transaction printer firmware. Currently, a firmware version must be created for each worldwide language to meet the various domestic and international requirements for gaming. Additionally, a firmware version must be created for each custom variation of a firmware version based on regional or jurisdictional specific information requirements, such as dual barcodes. The problem with the current situation is that as the gaming market continues to grow, any future expansion may become unmanageable as multiple firmware versions based on one firmware version will exist. This potentially unmanageable situation may be detrimental to a Gaming Establishment specifically since regulatory requirements and approvals are based on firmware versions. The use of the wrong version may cause the shut down of a Gaming Establishment by a regulatory agency.

Another area for improvement is supporting multiple host and multiple game protocols. Currently, a firmware version must exist for each protocol. These protocols include RS232, USB, Netplex, EPI, and Ethernet, among others. A drawback to the current situation is that firmware, including required communication drivers and jurisdictional content, must be reloaded each time a printer is placed to another system with a different protocol.

### DEFINITIONS

“Gaming Establishment”—A casino in the traditional sense, or other place where gambling takes place.

“Gaming Machine” or “Slot Machine”—A casino electromechanical game of chance. A Slot Machine as it is known is a sub-set of such games.

“Gaming Voucher”—A media, such as paper, containing sufficient information to identify at a minimum, an amount of money and a validation number use to authenticate the transaction.

“Promotional Coupon”—A media, such as paper, containing sufficient information to identify at a minimum, a promotional offer made to a patron.

“Host System”—A computer, back-end system, or gaming machine that sends and/or receives information to and/or from the financial transaction printer.

### SUMMARY OF THE INVENTION

The present invention provides a solution to the problems discussed above by allowing one integrated firmware version that utilizes Unicode to support each worldwide language, such as German, Korean, or Japanese. One benefit to using the present invention is as the one integrated firmware version resides in the financial transaction printer, a Gaming Establishment may easily, efficiently, and securely implement cashless enabled games and gaming in various countries, regions, or jurisdictions without the need to create another firmware version specifically for each country, region, or jurisdiction. Supporting this benefit, the present invention provides a localized method by which a Gaming Establishment may configure the financial transaction printer to a specific location.

Furthermore, the present invention permits all protocols to coexist in the firmware whereby security measures and various means are used to allow the financial transaction printer to detect which protocol it is using.

Additionally, the present invention provides a solution to regional and jurisdictional requirements by providing regional and jurisdictional message processing whereby custom variations in a firmware version may exist with only one firmware version.

The present invention is a financial transaction printer that interfaces with multiple host systems and multiple gaming machine protocols, downloads application code or code patches, receives printer maintenance instructions, arbitrates print jobs received from various communication interfaces, supports worldwide languages, and utilizes firmware version consolidation whereby fewer firmware versions are required to support worldwide requirements, such as regional and jurisdictional requirements. The financial transaction printer further includes security features such as encryption for gaming regulatory requirements, memory protection, and preventing the execution of downloaded code on unauthorized hardware. The financial transaction printer further includes segmented memory for content related to each communication interface, gaming machine, or host system, among others. Additionally, the financial transaction printer supports Unicode, configuration to worldwide languages, configuration to multiple protocols, and configuration to prior firmware versions for backward compatibility, among others.

In one aspect of the invention, a financial transaction printer includes a processor, memory, firmware, processes, programming logic, a print mechanism, a storage device, a printer controller, and a plurality of communication interfaces such as a communication port or driver.

In another aspect of the invention, the financial transaction printer includes a communication interface for connection to a host system, plurality of host systems, or gaming machine whereby the financial transaction printer may receive instructions to generate a gaming voucher, promotional coupon, plurality of any, combination of any, configuration to worldwide languages, configuration to one or multiple protocols, configuration to prior firmware versions for backward compatibility, code patches, printer maintenance instructions, application code including code from host system applications, gaming applications, promotional applications, and application code patches, among other types of information, for use in the financial transaction printer.

In another aspect of the invention, the financial transaction printer includes a communication interface for connection to an external device, whereby the financial transaction printer may receive from an external device configuration to worldwide languages, configuration to one or multiple protocols configuration to prior firmware versions for backward compatibility, code patches, printer maintenance instructions, application code including code from host system applications, gaming applications, promotional applications, and application code patches, among other types of information, for use in the financial transaction printer.

In another aspect of the invention, the financial transaction printer includes multiple drivers to interface to a plurality of host systems.

In another aspect of the invention, the financial transaction printer includes multiple concurrent drivers to interface to a plurality of gaming machines.

In another aspect of the invention, the financial transaction printer using memory, processes, programming logic, and firmware realizes firmware version consolidation whereby fewer firmware versions are required to support worldwide requirements, such as language and regional and jurisdictional requirements.

In another aspect of the invention, the financial transaction printer using firmware, memory, processes, and programming logic includes a security attribute for regulatory requirements, whereby the security attribute separates and segments the code and memory for each communication interface to the financial transaction printer.

In another aspect of the invention, the financial transaction printer using memory, processes, and programming logic includes a security attribute to protect the financial transaction printer memory and portions thereof from unauthorized reading or writing.

In another aspect of the invention, the financial transaction printer using memory, processes, and programming logic includes a security attribute to prevent the execution of downloaded code on unauthorized hardware.

In another aspect of the invention, the memory of the financial transaction printer is segmented.

In another aspect of the invention, a portion of the segmented memory of the financial transaction printer is utilized for gaming machine content such as machine implementation information, application code, mapping to specific gaming machine regions, templates, ticket files, coupon files, or gaming code patches.

In another aspect of the invention, a portion of the segmented memory of the financial transaction printer is utilized for coupon information such as promotion implementation information, application code, mapping to ticket files, coupon files, printer regions, or promotion code patches.

In another aspect of the invention, a portion of the segmented memory of the financial transaction printer is utilized for host system content such as implementation information, application code, and mapping to ticket files, coupon files, printer regions, or code patches.

In another aspect of the invention, a portion of the segmented memory of the financial transaction printer is utilized for mapping to a main communication interface, the mapping may further include identifying the gaming machine connected to the communication interface, mapping ticket files, mapping coupon files, downloaded gaming application code, downloaded promotion application code, templates, and code patches, and maintenance functions, among others.

In another aspect of the invention, a portion of the segmented memory of the financial transaction printer is utilized for mapping to a secondary communication interface, the mapping may further include identifying the host machine connected to the communication interface, mapping ticket files, mapping coupon files, downloaded gaming application code, downloaded promotion application code, templates, and code patches, and maintenance functions, among others.

In another aspect of the invention, a portion of the segmented memory of the financial transaction printer is utilized for mapping to an auxiliary communication interface, the mapping may further include downloaded gaming application code, download promotion application code, templates, and code patches, and maintenance functions, among others.

In another aspect of the invention, the firmware, memory, processes, and programming logic includes determining the existence of custom variations in a firmware version.

In another aspect of the invention, the financial transaction printer and components thereof interface to different host systems protocols.

In another aspect of the invention, the financial transaction printer and components thereof simultaneously interface to different host systems protocols.

In another aspect of the invention, the financial transaction printer and components thereof detect different host system communication interfaces and automatically detect and connect to different host protocols.

In another aspect of the invention, the financial transaction printer and components thereof interface to different gaming machine protocols.

In another aspect of the invention, the financial transaction printer and components thereof simultaneously interface to different gaming machines protocols.

In another aspect of the invention, the financial transaction printer and components thereof detect different gaming machines communication interfaces and automatically detect and connect to different gaming machine protocols.

In another aspect of the invention, the financial transaction printer and components thereof segment code and data of each adaptation or protocol to ensure no cross effects of new code modifications or adaptations.

In another aspect of the invention, the financial transaction printer generates or prints financial transaction records such as gaming vouchers, promotional coupons and other printed items of interest to a Gaming Establishment or its patrons.

In another aspect of the invention, the financial transaction printer detects a connection made on any or all communication interfaces.

In another aspect of the invention, the financial transaction printer and components thereof receive configuration data related to a specific country, region, or jurisdiction, or a plurality of countries, regions, or jurisdictions.

In another aspect of the invention, the financial transaction printer using a processor, memory, processes, and programming logic detects to which host system protocol or plurality of protocols the financial transaction printer is coupled, the protocol of each host system may include RS232, EPI, or Ethernet, among others.

In another aspect of the invention, the financial transaction printer using a processor, memory, processes, and programming logic detects to which gaming machine protocol or plurality of protocols the financial transaction printer is coupled, the protocol of each gaming machine may include USB, RS232, Netplex, or GSA, among others.

In another aspect of the invention, the financial transaction printer using a communication interface, programming logic, memory, and processes accepts initial game configuration of multiple variations in one data packet.

In another aspect of the invention, the financial transaction printer using a processor, memory, processes, and one or a plurality of communication downloads application code from a host system or host systems to which the financial transaction printer is connected, the application code including code from host system applications, gaming applications, promotional applications, and application code patches, among others.

In another aspect of the invention, the financial transaction printer using a processor, memory, processes, and one or a plurality of communication interfaces downloads application code from a gaming machine to which the financial transaction printer is connected, the application code including code from gaming applications, promotional applications, and application code patches, among others.

In another aspect of the invention, the financial transaction printer using a processor, memory, processes, and programming logic arbitrates print jobs received from one or a plurality of communication interfaces, such as a gaming voucher data from the main communication interface and promotional data from a secondary communication interface.

In another aspect of the invention, the financial transaction printer using a processor, memory, processes, programming logic, and firmware supports multiple worldwide languages, the financial transaction printer further detects which worldwide language is in use.

In another aspect of the invention, the financial transaction printer using memory, processes, programming logic, and firmware uniquely identifies worldwide languages.

In another aspect of the invention, the financial transaction printer using memory, processes, programming logic, and firmware uniquely identifies worldwide regions.

In another aspect of the invention, the financial transaction printer using memory, processes, programming logic, and firmware uniquely identifies worldwide jurisdictions.

In another aspect of the invention, the encoding method utilized in the financial transaction printer supports Unicode.

In another aspect of the invention, the financial transaction printer and components thereof print Unicode and other character transformation formats.

In another aspect of the invention, the financial transaction printer and components thereof accept the download of code and data from a host system.

In another aspect of the invention, the financial transaction printer and components thereof automatically negotiate the connection to the gaming machine by monitoring the physical and protocol layers of a communication interface to the gaming machine.

In another aspect of the invention, the financial transaction printer and components thereof automatically negotiate the connection to the host system by monitoring the physical and protocol layers of a secondary communication interface to the host.

In another aspect of the invention, the financial transaction printer supports multiple connections to hosts and/or game machines having different operating systems by using one or more operating system data environments stored in memory and dedicated to each of the different operating systems. The financial transaction printer may context switch between the different operating system data environments by either time slicing, such as switching between operating system data environments periodically, or by events, such as switching between operating system data environments when certain events occur.

### BRIEF DESCRIPTION OF THE DRAWINGS

These and other features, aspects, and advantages of the present invention will become better understood with regard to the following description and accompanying drawings where:

FIG. 1 is an illustration of the various interfaces to which a financial transaction printer may connect in accordance with an exemplary embodiment of the present invention.

FIG. 2 is a block diagram of a printer controller used to control a financial transaction printer in a gaming environment in accordance with an exemplary embodiment of the present invention.

FIG. 3 is an illustration of the segmented memory and memory map of the financial transaction printer in accordance with an exemplary embodiment of the present invention.

FIG. 4 is a sequence diagram of a process for confirming the contents of the section printer memory in accordance with an exemplary embodiment of the present invention.

FIG. 5 is a diagram of a security test performed on the memory of the financial transaction printer in accordance with an exemplary embodiment of the present invention.

FIG. 6 is an illustration of print arbitration process of the financial transaction printer in accordance with an exemplary embodiment of the present invention.

FIG. 7 is a diagram of a system connection check process used by the financial transaction printer in accordance with an exemplary embodiment of the present invention.

FIG. 8 is a diagram illustrating various layers of data from a protocol to the financial transaction printer in accordance with an exemplary embodiment of the present invention.

FIG. 9 is a block diagram of a printer controller used to control a financial transaction printer having multiple operating system data environments in accordance with an exemplary embodiment of the present invention.

### DETAILED DESCRIPTION

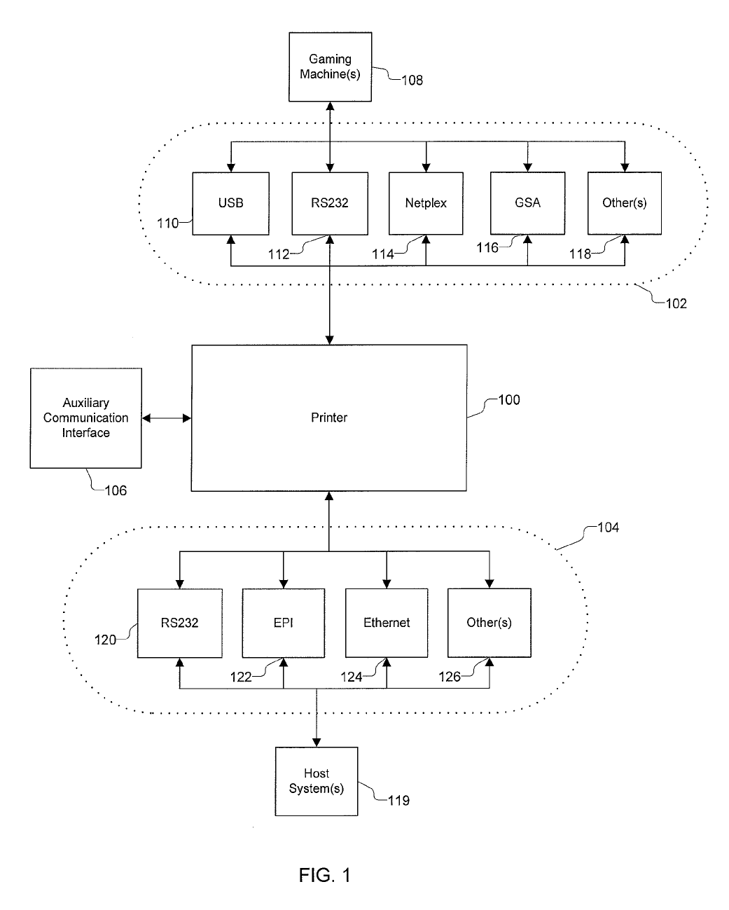

FIG. 1 is an illustration of the various communication interfaces by which a financial transaction printer is connected in accordance with an exemplary embodiment of the present invention.

The financial transaction printer 100 has a plurality of communication interfaces illustrated as main communication interface 102, secondary communication interface 104, and auxiliary communication interface 106. The main communication interface 102 provides a connection with one or more gaming machines 108 using a plurality of interfaces or protocols such as USB 110, RS232 112, Netplex 114, GSA 116, or others 118.

The secondary communication interface 104 provides a connection with one or more host systems' 119 interfaces or protocols such as RS232 120, EPI 122, Ethernet 124, or others 126.

The auxiliary communication interface 106 provides a connection to external devices such as a host system, reference printer, or handheld device (not shown).

In one embodiment, the financial transaction printer simultaneously interfaces with a plurality of host systems. Additionally, the financial transaction printer automatically detects and connects to different host systems and gaming machines using different corresponding protocols as utilized by the connected host systems and gaming machines.

In one financial transaction printer in accordance with an exemplary embodiment of the present invention, the main communication interface 102 may be of a singular physical connection. In this case, the financial transaction printer can monitor or detect the type and status of a network or communications physical layer of the main communication interface to the gaming machine 108 as well as a protocol layer of the main communication interface to the gaming machine, to automatically adjust to the physical and protocol layers used by the gaming machine and begin communications with the gaming machine.

In one financial transaction printer in accordance with an exemplary embodiment of the present invention, the secondary communication interface 104 may be of a singular physical connection. In this case, the financial transaction printer can monitor or detect the type and status of a physical layer of the secondary communication interface to the host and the protocol layer of the secondary communication interface to the host 119, to automatically adjust to the physical and protocol layers of the host and begin communications with the host.

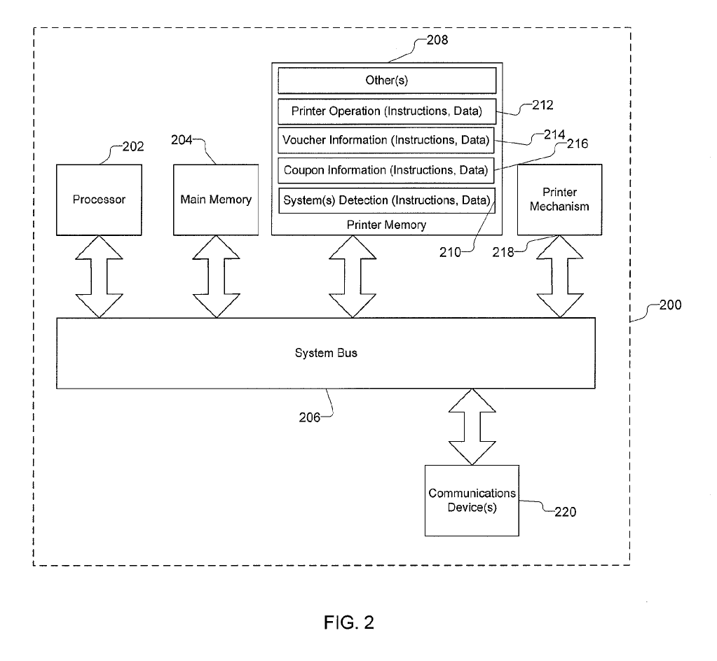

FIG. 2 is a block diagram of a printer controller used to control a financial transaction printer in a gaming environment in accordance with an exemplary embodiment of the present invention. A component or plurality of components shown in FIG. 2 may be optional.

As illustrated, the financial transaction printer controller 200 includes a processor 202 coupled to a main memory 204 by a system bus 206. The financial transaction printer controller also includes a financial transaction printer memory 208 coupled to the processor by the system bus, the financial transaction printer memory includes the firmware for system detection 210, printer operation 212, voucher information 214, coupon information 216, and others. Furthermore, the financial transaction printer memory stores the firmware and data in memory sections that may be independently addressed for both content read and content write operations.

The financial transaction printer memory, either internal and/or external, may consist of such common devices as RAM, EPROM, EEPROM, FLASH Chips, magnetic storage devices such as floppy or hard drivers, Flash Sticks and other storage media commonly used in the computer industry.

The printer operation section is included for storage of programming instruction codes and printer data used by the processor to operate the financial transaction printer. The execution of these codes determines the conditions under which voucher information, including voucher generation instructions and voucher data included in a voucher information section are utilized to generate a gaming voucher. A coupon information section included in the financial transaction printer memory holds coupon generation instructions and coupon data used by the financial transaction printer to generate a promotional coupon.

The system detection section of the financial transaction printer memory may be used by the financial transaction printer to configure itself after power up to perform gaming voucher printing, promotional coupon printing, or a combination thereof based on the system or plurality of systems detected. The system detection section may also detect whether the financial transaction printer is operating in a cashless enabled game or gaming table within a gaming system, a promotional system, or a combination thereof without cycling the power to the financial transaction printer. Upon detection of a gaming system, the system detection section of the financial transaction printer memory may then interact with the financial transaction printer operation section and voucher information section of the financial transaction printer memory to allow the financial transaction printer to generate gaming vouchers. Upon detection of a promotional system, the system detection section of the financial transaction printer memory may then interact with the financial transaction printer operation section and coupon information section of the financial transaction printer memory to allow the financial transaction printer to generate promotional coupons. Upon detection of dual systems of both gaming and promotional systems, the system detection section of the financial transaction printer memory may then interact with the financial transaction printer operation section, the voucher information section, and the coupon information section of the financial transaction printer memory to allow the financial transaction printer to function with a cashless enabled game or gaming table to generate gaming vouchers and, if necessary or available, promotional coupons.

Generally, the contents of the financial transaction printer operation section are not changed frequently. The contents of the voucher information section describe the format of the information that is printed on a gaming voucher. Contents of the voucher information section are changed rarely. The coupon information section includes the data that describes the format of the information that is printed on a promotional coupon. The contents of the coupon information section are changed frequently. The contents of system detection section are changed rarely.

The financial transaction printer controller is also coupled via the system bus to a printer mechanism 218 used to generate gaming vouchers or promotional coupons in accordance with the voucher data and the coupon data stored in the financial transaction printer memory.

One or a plurality of communication devices 220 may be coupled to the system bus for use by the financial transaction printer controller to communicate with a cashless gaming system host or a game controller and or a promotional system host or promotional controller, among others. The financial transaction printer controller uses the communication devices to receive commands, program instructions, voucher data, and coupon data from the external devices. In addition, the financial transaction printer controller may use the communication devices to transmit printer status information to the external devices. Other communication devices may also be used by the financial transaction printer controller to couple in a secure fashion over a local area network for administrative or other purposes.

Additional communication devices and channels may be provided for communication with other peripheral devices as needed. For example, one communication device may be provided with a local communications port, accessible from an exterior of a gaming machine that a technician may use to communicate with the financial transaction printer controller using an infrared link, other short-range wireless communication link, or a hard link with an external connector in a secure manner.

In operation, the processor loads the programming instruction codes included in the financial transaction printer operation section into the main memory and executes the programming instruction codes to implement the features of the financial transaction printer described herein.

The partitioning of the memory into separate code and data sections allows separate digital signatures to be maintained for each section. A signature, as an example the mathematical formula, may be generated for the memory content of a first section, such as the financial transaction printer operation content, independently of all other memory sections. A second signature, again as an example of a mathematical formula, may be generated for a second memory section, such as the voucher data section, independently of all other memory sections. A third signature, again as an example of a mathematical formula, may be generated on a third memory section, such as the coupon section, independently of all other memory sections. The signatures provide an identifier that is statistically unique in describing the contents of each memory section. A fourth signature, again as an example of a mathematical formula, may be generated on a fourth memory section, such as the systems detection section, independently of all other memory sections. In addition, a signature may be generated for all the memory sections combined.

In practical use, the sectioned printer memory allows the contents of the second section and/or third section to be viewed individually and separately from the contents of the first section. The mathematical formula used to generate the statistically unique identifier or signature of the financial transaction printer has not changes, through alteration of the programming instruction codes or by other means.

The second section and third section may contain the content of the printed image of a gaming voucher and a promotional coupon, respectively. For example, in the case of a promotional coupon, a gaming establishment operator may want to change the image and contents of the promotional coupon frequently. In this case, the gaming establishment may then change just the third section of memory including the coupon data without disturbing the first section of memory. The conditions that cause the gaming voucher and/or promotional coupon to be printed are controlled by the cashless enabled game or gaming table in accordance with the programming instruction codes and the coupon data.

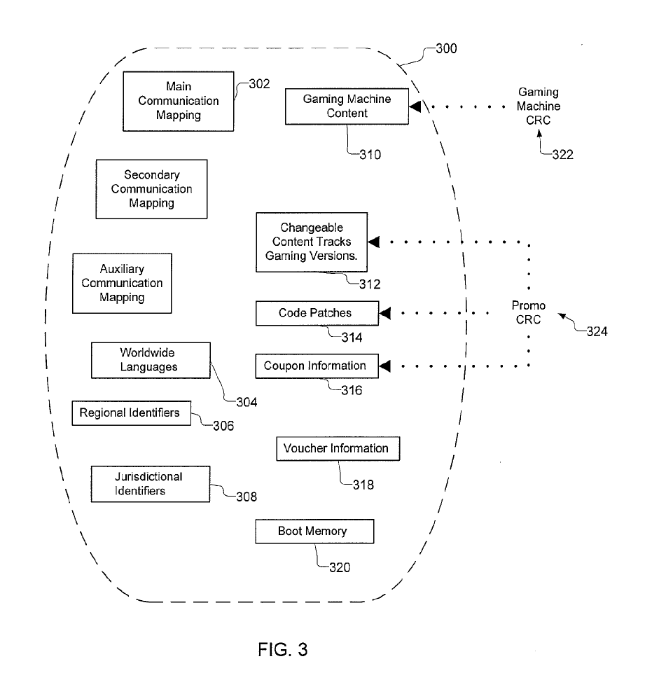

FIG. 3 is an illustration of the segmented memory and memory map of the financial transaction printer in accordance with an exemplary embodiment of the present invention.

The segmented memory 300 includes all memory storage previously disclosed in FIG. 2. Additionally, the memory may include areas for main communication mapping, secondary communication mapping, auxiliary communication mapping 302, worldwide languages 304, regional identifiers 306, jurisdictional identifiers 308, gaming machine content 310, changeable content tracks gaming versions 312, code patches 314, coupon information 316, voucher information 318, and boot memory 320.

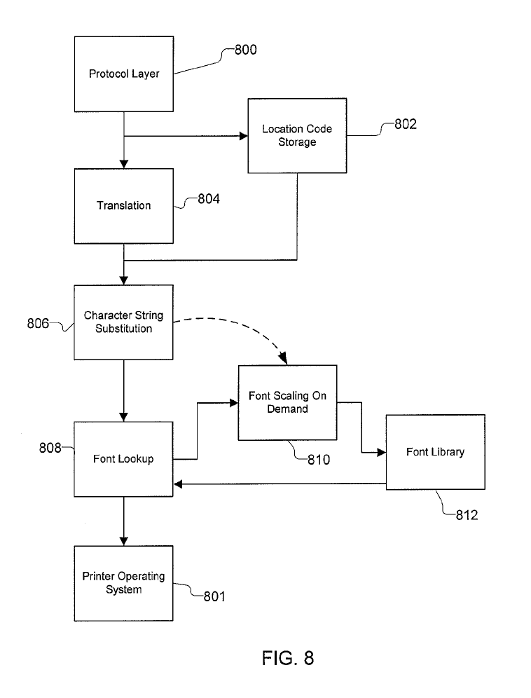

The main communication mapping area of the financial transaction printer memory may be used for mapping to a gaming machine. Contents for mapping may include among others the currently active gaming machine interface, mapping to ticket files, mapping to coupon files, and gaming machine implementation information. Additionally, the main communication mapping area of the financial transaction printer memory may be used for downloading capabilities for gaming machine application code, gaming machine application code patches, gaming machine templates, promotional codes, promotional templates, promotional code patches, configuration to one or multiple worldwide languages, regions, or jurisdictions, configuration to one or multiple protocols as later disclosed in FIG. 8, configuration to prior firmware versions, and printer maintenance functions. The main communication mapping area may also include processes that allow for print arbitration awareness and additional communication interface awareness.

The secondary communication mapping area of the financial transaction printer memory may be used for mapping to a host system, a plurality of host systems, and or a gaming machine. Contents for mapping may include among others the currently active host system, plurality of host systems, or gaming machine interface, mapping to ticket files, mapping to coupon files, and host system or systems implementation information. Additionally, the secondary communication mapping area of the financial transaction printer memory may be used for downloading capabilities for application code from a host system, a plurality of host systems, or a gaming machine, application code patches from a host system, a plurality of host systems, or a gaming machine, promotional codes, promotional templates, promotional code patches, configuration to one or multiple worldwide languages, regions, or jurisdictions, configuration to one or multiple protocols as later disclosed in FIG. 8, configuration to prior firmware versions, and printer maintenance functions. The secondary communication mapping area may also include processes that allow for print arbitration awareness and additional communication interface awareness.

The auxiliary communication mapping area of the financial transaction printer memory may be used for mapping to an external device. Contents for mapping may include among others printer maintenance functions as well as downloading capabilities for gaming machine application code, gaming machine application code patches, gaming machine templates, promotional codes, promotional templates, promotional code patches, configuration to one or multiple worldwide languages, regions, or jurisdictions, configuration to one or multiple protocols as later disclosed in FIG. 8, and configuration to prior firmware versions. Additionally, the auxiliary communication mapping area of the financial transaction printer memory may include processes that allow for print arbitration awareness and additional communication interface awareness.

The worldwide languages area of the financial transaction printer memory may be used to support configuration to languages used worldwide, such as Korean, German, and Japanese as well as the ability to detect which language is in use and identify the worldwide language using a unique identifier.

The regional identifiers area of the financial transaction printer memory may be used to support worldwide regional requirements by gaming regulators and other regulating agencies, such as a unique identifier for each region.

The jurisdictional identifiers area of the financial transaction printer memory may be used to support worldwide jurisdictional requirements by gaming regulators and other regulating agencies, such as a unique identifier for each jurisdiction.

Data from the worldwide languages area, the regional identifiers area, and the jurisdictional identifiers area, among others, may be used in the location code storage layer as later disclosed in FIG. 8.

The gaming machine content area of the financial transaction printer memory may be used for information related to the gaming machine such as gaming machine implementation information and a table identifying each gaming machine application code patch. Additional information in this area of the financial transaction printer memory may include mapping to specific gaming machine regions, gaming machine templates, a specific ticket file, and a specific coupon file. This area may be used to create a gaming machine CRC signature 322 or other signature as a security attribute.

The changeable content tracks gaming versions area of the financial transaction printer memory may be used for information related to content that may be modified in gaming machines versions such as all print regions, all ticket files, all coupon files, and any tables containing conversion data for worldwide configuration.

The code patches area of the financial transaction printer memory may be used to create a link between gaming machine code patch table from the gaming machine content area and the promotional code patch table from the coupon information area.

The coupon information area of the financial transaction printer memory may be used for information related to promotions such as promotion implementation information, a table identifying each promotion code patch, and instructions and data as previously disclosed in FIG. 2.

The voucher information area of the financial transaction printer memory may be used for information related to gaming vouchers such as instructions and data as previously disclosed in FIG. 2.

The changeable contents tracks gaming versions, code patches, and coupon information areas of the financial transaction printer memory may be used to create a promotional CRC signature 324 as a security attribute.

The boot memory may be used for processes and other information related to financial transaction printer during power up or when the power is recycled, among others.

In one embodiment, the fields of a gaming voucher or promotional coupon may be described using description data included in an electronic template that may be stored by a printer in the financial transaction printer memory such as in the gaming machine content area, the coupon information area, or the voucher information area. These fields may include a barcode field, text field, a graphic field, and line/box draw field. A template may include a plurality of these fields in combination, resulting in a paste-up style printed gaming voucher or promotional coupon. A plurality of templates describing different types of gaming vouchers may be stored in the voucher information section of the financial transaction printer memory to be used by the financial transaction printer to support the gaming operations of a gaming establishment. Similarly, a plurality of templates describing different types of promotional coupons may be stored in the coupon information section of the financial transaction printer memory to be used by the financial transaction printer to support the promotional operations of a gaming establishment.

The actual value or data for each of the fields described in a template may or may not be included in the template itself. Instead, the template may include instructions on how to generate a gaming voucher or promotional coupon but may not include the actual data printed onto the gaming voucher or promotional coupon. For example, a template may include a barcode field for printing a barcode. However, the actual value of the barcode is transmitted to a printer from a host system at the time a gaming voucher or promotional coupon is generated using the template. In this way, a gaming voucher or promotional coupon may have fields that include static data, such as a logo in a graphic field, or dynamic data, such as the name of a patron in a text field. In this way, customized gaming vouchers or promotional coupons may be printed by a printer without transferring large amounts of data through a communications device.

A template may include a plurality of command strings. Each command string may conform to the following example syntax:
delimiter<cmd_Ltr>|<data_field1>| . . . |<data_fieldx>|delimiter;comment
   where:
delimiter=a delimiter character
<cmd_Ltr>=command identifier letter
   |=pipe character. This serves as the delimiter between data fields in a command.
<data_field1−x>fields that include information relative to the command.
; semi-colon. This is a comment field designator.
comment=any comments.

A template may adhere to the following syntax:

delimiter<template_cmd_Ltr>|<t_id>|<targ_mem>|<t_dim_da>|<t_dim_pa>|
<pr#1>|<pr#2>|...|<pr#n>|delimiter

where
<t_id>=the template I.D.
<targ_mem>=target memory storage.
<t_dim_da>=template dimension on a dotline axis in dots.
<t_dim_pa>=template dimension in dots in the paper axis.
<pr#1> . . . <pr#n>=list of gaming vouchers or promotional coupon data resident print regions IDs used in the format of the gaming voucher or promotional coupon. These fields are the method by which print regions used on a gaming voucher or promotional coupon are linked together and to the template.

A print region is a print field used in a template to format print data. The print region command is used to define the basic types of print regions such as text, barcode, graphics, and line/box draw.

A define print region command defines the particular font, barcode, graphic, or line style that is to be used, and provides special formatting information on how it is to be used. Multiple print regions may be defined and memorized in a printer's sectioned memory.

As an example, the host system may transmit gaming voucher data or promotional coupon data to the financial transaction printer to generate a gaming voucher or promotional coupon, respectively. To further describe, the host system may also include a reference to a template definition so that the dynamic data transmitted by the host system can be combined with the static data stored in the financial transaction printer to generate a complete gaming voucher or promotional coupon depending on the host system. Additionally, since it is possible to store all the fields used on a gaming voucher or promotional coupon with the financial transaction printer memory, a host system may issue a complete gaming voucher or promotional coupon by simply sending a reference to a gaming voucher or promotional coupon stored in the financial transaction printer memory to generate the gaming voucher or promotional coupon in its entirety.

In another embodiment, the fields of a gaming voucher or promotional coupon and instructions on how to generate a gaming voucher or promotional coupon may not be used an electronic template for the generation of a gaming voucher or promotional coupon. The fields may include any or all those previously described.

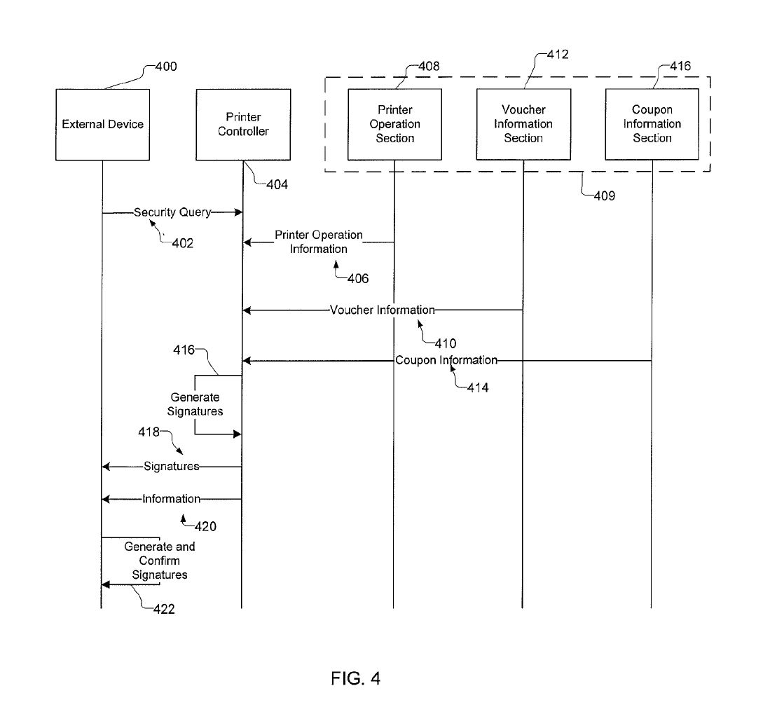

FIG. 4 is a sequence diagram of a process for confirming the contents of a section of printer memory in accordance with an exemplary embodiment of the present invention.

An external device 400, such as a host system, reference printer, or handheld device may transmit a security request or query 402 to a printer controller 404. In response to the security request, the financial transaction printer controller reads printer operation information 406 from the financial transaction printer operation section 408 of the financial transaction printer memory 409. The financial transaction printer controller may also read voucher information 410 from the voucher information section 412 and coupon information 414 from the coupon information section 416. The financial transaction printer controller may then generate 416 individual signatures for each of the memory sections and a total signature for the financial transaction printer memory. The signatures 418 may then be transmitted to the external device for further processing.

Alternatively, the financial transaction printer controller may transmit all or part of the read information to 420 the external device. The external device then may generate 422 individual or total signatures for the transmitted information to confirm the contents of the financial transaction printer memory.

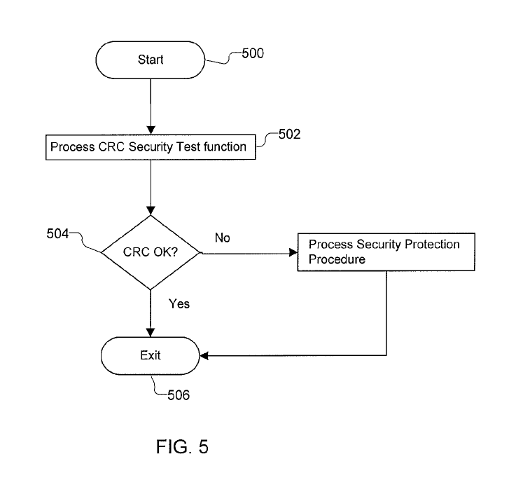

FIG. 5 is a diagram of a security test performed on the memory of the financial transaction printer in accordance with an exemplary embodiment of the present invention.

As illustrated, the process begins (500) with the processing (502) of the CRC security test. If the CRC is verified (504) and the contents or code have not changed, the process ends (506). Otherwise, a security protection procedure is processed (508).

An example security protection procedure may perform all of the following checks to determine the validity of memory contents of the financial transaction printer: a security check on the gaming machine CRC, promotional CRC, boot memory, and any code patches. If at any time, a function of the process fails, an error report may be returned to a host system and printer functions and/or execution of applications may be prevented or halted.

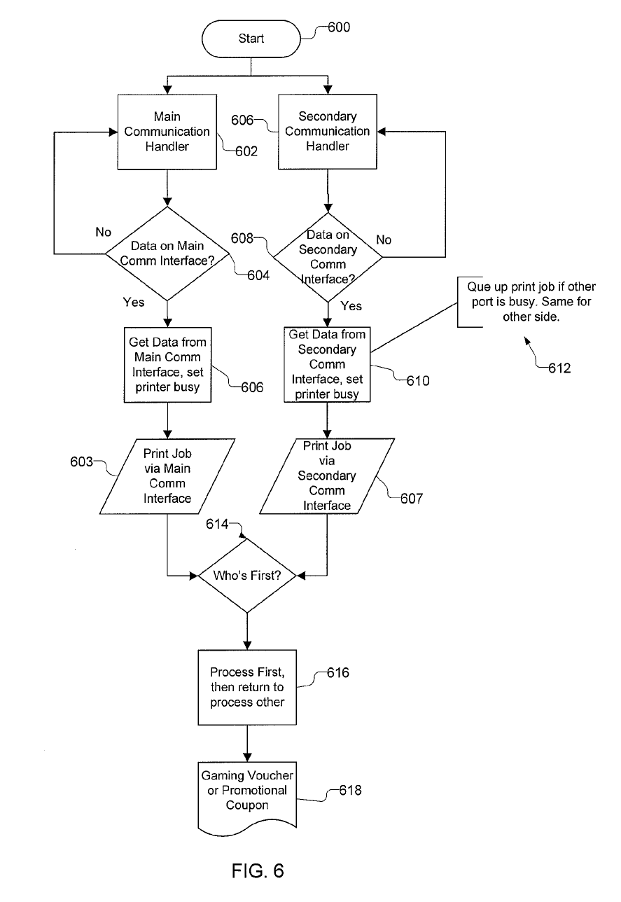

FIG. 6 is an illustration of print arbitration process of the financial transaction printer in accordance with an exemplary embodiment of the present invention.

As illustrated, the process for the main communication interface begins (600) with the main communication handler 602. If data 603 such as a gaming voucher exists (604) on a main communication interface, the system gets the data from the main communication interface and sets the financial transaction printer to busy (606). If data does not exist on the main communication interface, the process returns to the main communication handler.

The process for the secondary communication interface begins with the secondary communication handler (606). If data 607 such as a promotional coupon exists (608) on the secondary communication interface, the system gets the data from the secondary communication interface and sets the financial transaction printer to busy (610). If data does not exist on the secondary communication interface, the process returns to the secondary communication handler.

If the financial transaction printer is busy using any communication interface, the data from the other communication interface is queued(612).

The process continues with the system identifying which data was received first (614). After identifying the data received first, the system processes (616) the first data to generate for instance a gaming voucher or promotional coupon 618, then returns to process the second data to generate for instance a gaming voucher or promotional coupon.

An example of one arbitration scheme would be the financial transaction printer always giving priority to a gaming voucher print job that comes from the gaming machine (on the main communication interface), and then queuing a coupon print job (on the secondary communication interface) behind the gaming voucher. Another example of an arbitration scheme would be the financial transaction printer receiving a coupon print job on its secondary communication interface, then holding the coupon for a period of time awaiting arrival of a gaming voucher on the main communication interface. If the gaming voucher did not arrive within a reasonable amount of time, the coupon could either be printed or canceled by the financial transaction printer. In addition to coupon print data, the financial transaction printer would receive certain static promotional campaign data on its secondary communication interface. The static data could include graphic icons that are necessary to print on the various coupons, portions of the coupons that would never change with an award, and optionally, a set of trigger conditions that would cause the financial transaction printer to trigger a coupon.

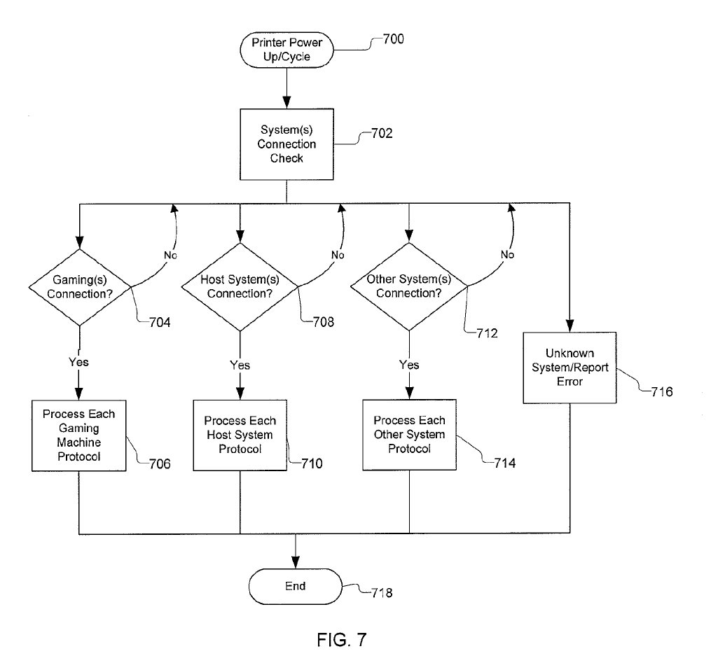

FIG. 7 is a diagram of a system connection check process used by the financial transaction printer in accordance with an exemplary embodiment of the present invention.

As illustrated, the process begins (700) with the financial transaction printer power up or cycle, after that a system connection check is performed (702) to establish communication with one or a plurality of gaming machines, one or a plurality of host systems, and one or a plurality of other systems. During the system connection check, the financial transaction printer may detect (704) that it is connected to one or a plurality of gaming machines, whereby the process continues with processing (706) each gaming machine protocol.

Also during the system connection check, the financial transaction printer may detect (708) that it is connected to one or a plurality of host systems, whereby the process continues with processing (710) the protocol of each host system.

Also during the system connection check, the financial transaction printer may detect (712) that it is connected to one or a plurality of other systems, whereby the process continues with processing (714) the protocol of each other system.

Also during the system connection check, the financial transaction printer may not detect a connection or may detect an unknown connection, whereby the process continues with an unknown system report or error being generated (716) and may be returned to a host system. Additionally, printer functionality may be halted (718).

This system connection check may process in a continual loop whereby once a detection is made, the process continues by checking for other connections. The process ends when no further connections are detected.

Additionally, a system connection check may be used to detect a new connection made to or from the financial transaction printer. In this embodiment, when a connection is detected to one or a plurality of systems or gaming machines, the protocol for each new connection is processed and the previously detected protocol may be disconnected. For example, the financial transaction printer is connected to a gaming machine protocol of RS232. The financial transaction printer is removed from the gaming machine and placed in a gaming machine using a protocol of Netplex or USB. Accordingly, the system connection check may disconnect communication with the RS232 protocol and process the Netplex or USB protocol.

In one embodiment, the financial transaction printer automatically detects and connects to a plurality of host and gaming machine protocols.

In another embodiment, after performing a system connection check, the financial transaction printer may simultaneously interface with multiple protocols, whereby the protocols may include one or a plurality of gaming machines, one or a plurality of host systems, one or a plurality of other systems, or a combination of any.

FIG. 8 is a diagram illustrating various layers of data from a protocol to the financial transaction printer in accordance with an exemplary embodiment of the present invention.

In one embodiment, the financial transaction printer operating system 801 may be coupled to a plurality of data layers such as a protocol layer 800, location code storage 802, a translation layer 804, a character string substitution layer 806, and a font lookup layer 808. Ideally, data may be derived from all layers to permit the financial transaction printer to properly function within any worldwide region using any protocol with the ability to generate gaming vouchers, promotional coupons, and other printed items of interest using any worldwide language. Additionally, any or all data layers may reside in the memory of the financial transaction printer as previously disclosed in FIG. 2 and FIG. 3.

The protocol layer may include all necessary information to connect with a communication interface. In a preferred embodiment, there may exist a plurality of protocol layers, such as USB, Netplex, and RS232, among others, each protocol includes a unique identifier.

The location code storage layer may include information relevant to one or a plurality of countries, one or a plurality of jurisdictions, one or a plurality of regions, and one or a plurality of properties belonging to a Gaming Establishment. Each location code may include a unique identifier for each country, each jurisdiction, each region, and each property. Data in this layer may include data from the worldwide languages, regional identifiers, and jurisdictional identifiers areas, among others, of the financial transaction printer memory as previously disclosed in FIG. 3.

The translation layer may be used to render a protocol for use with the financial transaction printer. The translation layer may include data from any area of the financial transaction printer memory as previously disclosed in FIG. 3.

The character string substitution layer may include information derived from the translation layer and the location code storage layer to properly encode the data. For example, the financial transaction printer may set the appropriate character string substitution using Unicode after the financial transaction printer identifies the protocol layer as USB and the country in the location code storage layer as Brazil. This functionality permits the financial transaction printer to generate or print gaming vouchers, promotional coupons, and other printed items of interest to a Gaming Establishment.

The font lookup table may include information related to the fonts supported by the financial transaction printer. Data may be drawn from any font scaling on demand 810 that may be pulled from the character string substitution layer as well as data from a font library 812 stored in the financial transaction printer.

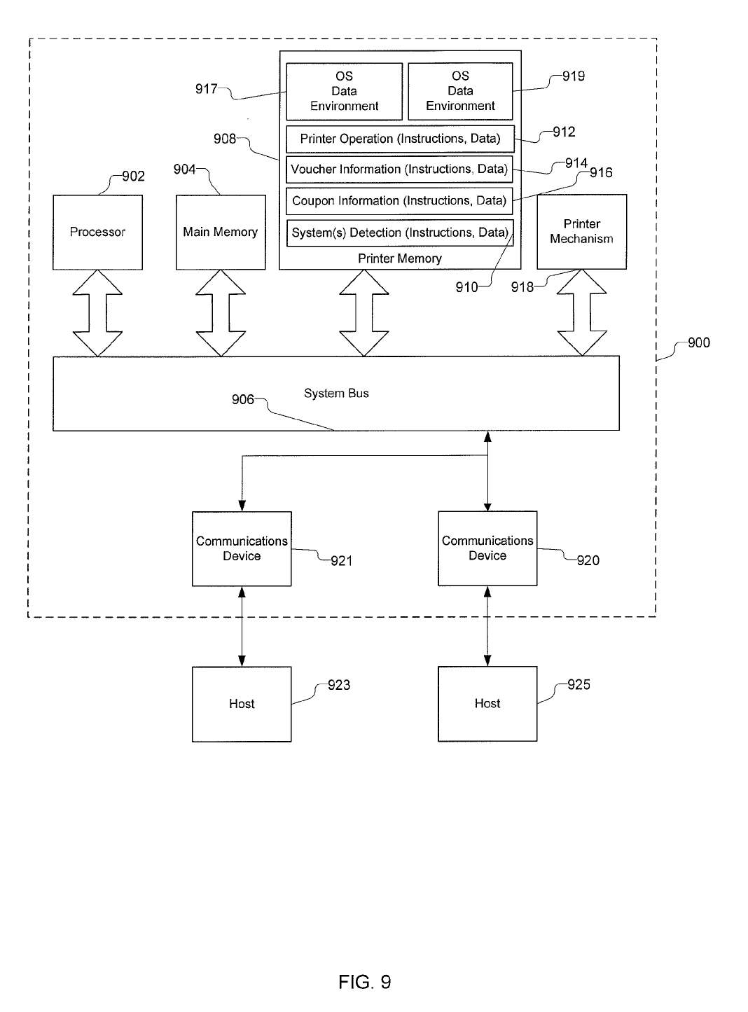

FIG. 9 is a block diagram of a printer controller used to control a financial transaction printer having multiple operating system data environments in accordance with an exemplary embodiment of the present invention.

As illustrated, the financial transaction printer controller 900 includes a processor 902 coupled to a main memory 904 by a system bus 906. The financial transaction printer controller also includes a financial transaction printer memory 908 coupled to the processor by the system bus, the financial transaction printer memory includes the firmware for system detection 910, printer operation 912, voucher information 914, coupon information 916, and a plurality of operating system data environments, such as operating system data environments 917 and 919. Furthermore, the financial transaction printer memory stores the firmware and data in memory sections that may be independently addressed for both content read and content write operations.

The financial transaction printer memory, either internal and/or external, may consist of such common devices as RAM, EPROM, EEPROM, FLASH Chips, magnetic storage devices such as floppy or hard drivers, Flash Sticks and other storage media commonly used in the computer industry.

The printer operation section is included for storage of programming instruction codes and printer data used by the processor to operate the financial transaction printer. The execution of these codes determines the conditions under which voucher information, including voucher generation instructions and voucher data included in a voucher information section are utilized to generate a gaming voucher. A coupon information section included in the financial transaction printer memory holds coupon generation instructions and coupon data used by the financial transaction printer to generate a promotional coupon.

The system detection section of the financial transaction printer memory may be used by the financial transaction printer to configure itself after power up to perform gaming voucher printing, promotional coupon printing, or a combination thereof based on the system or plurality of systems detected. The system detection section may also detect whether the financial transaction printer is operating in a cashless enabled game or gaming table within a gaming system, a promotional system, or a combination thereof without cycling the power to the financial transaction printer. Upon detection of a gaming system, the system detection section of the financial transaction printer memory may then interact with the financial transaction printer operation section and voucher information section of the financial transaction printer memory to allow the financial transaction printer to generate gaming vouchers. Upon detection of a promotional system, the system detection section of the financial transaction printer memory may then interact with the financial transaction printer operation section and coupon information section of the financial transaction printer memory to allow the financial transaction printer to generate promotional coupons. Upon detection of dual systems of both gaming and promotional systems, the system detection section of the financial transaction printer memory may then interact with the financial transaction printer operation section, the voucher information section, and the coupon information section of the financial transaction printer memory to allow the financial transaction printer to function with a cashless enabled game or gaming table to generate gaming vouchers and, if necessary or available, promotional coupons.

Generally, the contents of the financial transaction printer operation section are not changed frequently. The contents of the voucher information section describe the format of the information that is printed on a gaming voucher. Contents of the voucher information section are changed rarely. The coupon information section includes the data that describes the format of the information that is printed on a promotional coupon. The contents of the coupon information section are changed frequently. The contents of system detection section are changed rarely.

The financial transaction printer controller is also coupled via the system bus to a printer mechanism 918 used to generate gaming vouchers or promotional coupons in accordance with the voucher data and the coupon data stored in the financial transaction printer memory.

One or more communication devices, such as communication devices 920 and 921, may be coupled to the system bus for use by the financial transaction printer controller to communicate with one or more external hosts or devices, such as hosts 923 and 925, which may be cashless gaming system hosts or game controllers and/or promotional system hosts or promotional controllers, or any combination thereof. The financial transaction printer controller uses the communication devices to receive commands, program instructions, voucher data, and coupon data from the external devices. In addition, the financial transaction printer controller may use the communication devices to transmit printer status information to the external devices. Other communication devices may also be used by the financial transaction printer controller to couple in a secure fashion over a local area network for administrative or other purposes.

Additional communication devices and channels may be provided for communication with other peripheral devices as needed. For example, one communication device may be provided with a local communications port, accessible from an exterior of a gaming machine that a technician may use to communicate with the financial transaction printer controller using an infrared link, other short-range wireless communication link, or a hard link with an external connector in a secure manner.

The financial transaction printer supports multiple connections to the plurality of hosts and/or game machines having different operating systems by using the operating system data environments stored in memory and dedicated to each of the different operating systems. In doing so, the financial transaction printer may context switch between the different operating system data environments by either time slicing, such as switching between operating system data environments periodically, or by events, such as switching when certain events occur and are detected by the financial transaction printer. The events may be communication events, such as communications sent to the financial transaction printer by one or more of the hosts, or events that occur within the financial transaction printer such as printing of a voucher or a coupon or the occurrence of an error in the financial transaction printer.

In operation, the processor loads the programming instruction codes included in the financial transaction printer operation section into the main memory and executes the programming instruction codes to implement the features of the financial transaction printer described herein.

The partitioning of the memory into separate code and data sections allows separate digital signatures to be maintained for each section. A signature, as an example the mathematical formula, may be generated for the memory content of a first section, such as the financial transaction printer operation content, independently of all other memory sections. A second signature, again as an example of a mathematical formula, may be generated for a second memory section, such as the voucher data section, independently of all other memory sections. A third signature, again as an example of a mathematical formula, may be generated on a third memory section, such as the coupon section, independently of all other memory sections. The signatures provide an identifier that is statistically unique in describing the contents of each memory section. A fourth signature, again as an example of a mathematical formula, may be generated on a fourth memory section, such as the systems detection section, independently of all other memory sections. In addition, a signature may be generated for all the memory sections combined.

In practical use, the sectioned printer memory allows the contents of the second section and/or third section to be viewed individually and separately from the contents of the first section. The mathematical formula used to generate the statistically unique identifier or signature of the financial transaction printer has not changes, through alteration of the programming instruction codes or by other means.

The second section and third section may contain the content of the printed image of a gaming voucher and a promotional coupon, respectively. For example, in the case of a promotional coupon, a gaming establishment operator may want to change the image and contents of the promotional coupon frequently. In this case, the gaming establishment may then change just the third section of memory including the coupon data without disturbing the first section of memory. The conditions that cause the gaming voucher and/or promotional coupon to be printed are controlled by the cashless enabled game or gaming table in accordance with the programming instruction codes and the coupon data.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

What is claimed:

1. A financial transaction printer comprising:
a processor;
a plurality of communication interfaces coupled to the processor for coupling the financial transaction printer to one or more host systems; and
a memory coupled to the processor, the memory storing a plurality of operating system data environments,
wherein the processor context switches from a first operating system data environment of the plurality of operating system environments to a second operating system data environment of the plurality of operating system data environments based upon a network layer of a host system coupled to the financial transaction printer by one of the communication interfaces of the plurality of communication interfaces.

2. The financial transaction printer of claim 1, wherein the context switching is performed on the basis of monitoring a layer of a communication interface coupled to a host system.

3. The financial transaction printer of claim 1, wherein the context switching is performed on the basis of time slicing.

4. The financial transaction printer of claim 1, wherein the context switching is performed on the basis of event detection.

5. The financial transaction printer of claim 4, wherein the consolidated firmware includes portions for supporting a plurality languages.

6. The financial transaction printer of claim 4, wherein the consolidated firmware includes portions for supporting regional requirements.

7. The financial transaction printer of claim 4, wherein the consolidated firmware includes portions for supporting jurisdictional requirements.

8. The financial transaction printer of claim 1, wherein a security attribute for regulatory requirements is used to separate and segment the firmware for each communication interface to the financial transaction printer.

9. The financial transaction printer of claim 1, wherein a security attribute is used to protect the financial transaction printer memory and portions thereof from unauthorized reading or writing.

10. The financial transaction printer of claim 1, wherein a security attribute is used to prevent the execution of downloaded code on unauthorized hardware.

11. The financial transaction printer of claim 1 wherein the memory is segmented, the segments comprising:
a segment for gaming machine content including machine implementation information and application code;
a segment for coupon information including promotion implementation information, application code, mapping to ticket files, coupon files, printer regions, and promotion code patches;
a segment for host system content including implementation information, application code, and mapping to ticket files, coupon files, printer regions, and code patches;
a segment for mapping to a main communication interface, the main communication interface mapping including identifying the gaming machine connected to the communication interface, mapping ticket files, mapping coupon files, downloaded gaming application code, downloaded promotion application code, templates, and code patches, and maintenance functions;
a segment for mapping to a secondary communication interface, the secondary communication interface mapping including identifying the host machine connected to the communication interface, mapping ticket files, mapping coupon files, downloaded gaming application code, downloaded promotion application code, templates, and code patches, and maintenance functions; and
a segment for mapping to an auxiliary communication interface, the auxiliary communication interface mapping may further including downloaded gaming application code, downloaded promotion application code, templates, and code patches, and maintenance functions.

12. The financial transaction printer of claim 1, wherein the communication interface coupled to a host system is constructed to interface to one or more host systems using one or more host systems protocols.

13. The financial transaction printer of claim 12, wherein the communication interface coupled to a host system is further constructed to detect a host system communication interface and automatically detect and connect using a corresponding host protocol.

15. The financial transaction printer of claims 12 and 13, wherein the host protocol is selected from a group including RS232, EPI, and Ethernet.

16. The financial transaction printer of claim 1, wherein the communication interface coupled to a host system is constructed to interface to one or more gaming machines using one or more gaming machine protocols.

17. The financial transaction printer of claim 16, wherein the communication interface coupled to a host system is further constructed to detect a gaming machine communication interface and automatically detect and connect using a corresponding gaming machine protocol.

18. The financial transaction printer of claim 16 or 17, wherein the gaming machine protocol is selected from the group comprising USB, RS232, Netplex, and GSA.

19. The financial transaction printer of claim 1, wherein the processor is further constructed to download application code from one or more host systems, the application code selected from a group including code for host system applications, code for gaming applications, code for promotional applications, and application code patches.

20. The financial transaction printer of claim 1, wherein the processor is further constructed to download application code from one or more gaming machines, the application code selected from the group including code from gaming applications, promotional applications, and application code patches.

21. The financial transaction printer of claim 1, wherein the processor is further constructed to support multiple worldwide languages and to detect which worldwide language is in use.

22. The financial transaction printer of claim 1, wherein the processor is further constructed to support multiple worldwide regions and to detect in which worldwide region the financial transaction printer is being utilized.

23. The financial transaction printer of claim 1, wherein the processor is further constructed to support multiple worldwide jurisdictions and to detect in which worldwide jurisdiction the financial transaction printer is being utilized.

24. The financial transaction printer of claim 1, wherein the processor is further constructed to support Unicode.

25. The financial transaction printer of claim 24, wherein the processor is further constructed to print Unicode and other character transformation formats.

26. The financial transaction printer of claim 1, wherein the processor is further constructed to receive configuration data related to one or more specified countries, regions, and jurisdictions.

27. The financial transaction printer of claim 1, wherein the processor is further constructed to accept initial game configuration of multiple variations in one data packet.

28. The financial transaction printer of claim 1, wherein the processor is further constructed to arbitrate print jobs for gaming voucher data received from a main communication interface and promotional data from a secondary communication interface.
